(19) United States
(12) Patent Application Publication
(10) Pub. No.: US 2024/0345550 A1
(43) Pub. Date: Oct. 17, 2024

(54) OPERATING STATE CHARACTERIZATION BASED ON FEATURE RELEVANCE

(71) Applicant: SparkCognition, Inc., Austin, TX (US)

(72) Inventors: Aditya Jain, San Francisco, CA (US); Kevin Gullikson, Pflugerville, TX (US)

(21) Appl. No.: 18/301,360

(22) Filed: Apr. 17, 2023

(51) Int. Cl. G05B 13/02; G05B 13/04

(52) U.S. Cl. CPC G05B 13/027; G05B 13/048

(57) ABSTRACT

A method includes providing input data to one or more machine-learning models to generate output data. The input data includes an input value for each of N features associated, and the output data includes a predicted value of each of M features. The method further includes determining M sets of feature relevance values including a set of feature relevance values for each of the M predicted values. A particular set of feature relevance values is associated with a particular predicted value, and each feature relevance value of the particular set of feature relevance values represents an estimate of a contribution of a respective one of the N input values to the particular predicted value. The method also includes aggregating feature relevance values to generate N aggregate feature relevance values and characterizing the operating state of the monitored asset based on the N aggregate feature relevance values.

### FIELD

The present disclosure is generally related to characterizing an operating state of one or more monitored assets based on feature relevance data.

### BACKGROUND

The operational behavior of industrial equipment and other similar assets may be monitored using rules established by a subject matter expert or derived from physics-based models. Historically, monitoring in this manner generally involved simple threshold-based monitoring. For example, if a particular sensed value exceeded a specified limit, an operator or other party was notified. While threshold-based monitoring is helpful, it tends to generate an alert after a problem already exists with a monitored asset.

There have been efforts to improve monitoring systems to predict how a monitored asset will operate in the future based on current or historical data. One advantage of these improved monitoring systems is that they may enable the owner or operator of a monitored asset to avoid predicted problems, such as by scheduling maintenance or changing the manner in which the monitored asset is operated. Avoiding predicted problems can improve safety, decrease costs, and improve availability of the monitored asset. However, it can be expensive and time consuming to properly establish and confirm the rules used to predict how a monitored asset will operate in the future. The time and expense involved is compounded if the monitored asset(s) have several normal operational states or if what behavior is considered normal changes from time to time. To illustrate, as equipment operates, the normal behavior of the equipment may change due to wear. It can be challenging to establish rules to monitor this type of gradual change in normal behavior. Further, in such situations, the equipment may occasionally undergo maintenance to offset the effects of the wear. Such maintenance can result in a sudden change in normal behavior, which is also challenging to monitor using established rules.

### SUMMARY

According to a particular aspect, a method includes providing input data to one or more machine-learning models to generate output data. The input data includes an input value for each of N features associated with an operating state of a monitored asset, where N is an integer greater than or equal to two. The output data includes a predicted value of each of M features, where M is an integer greater than or equal to two. The method further includes determining M sets of feature relevance values including a set of feature relevance values for each of the M predicted values. A particular set of feature relevance values is associated with a particular predicted value, and each feature relevance value of the particular set of feature relevance values represents an estimate of a contribution of a respective one of the N input values to the particular predicted value. The method also includes aggregating, across the M sets of feature relevance values, feature relevance values for each of the N features to generate N aggregate feature relevance values. The method further comprises characterizing the operating state of the monitored asset based at least in part on the N aggregate feature relevance values.

According to another particular aspect, a system includes one or more memory devices storing processor-executable instructions and one or more processors configured to execute the instructions. The instructions, when executed, cause the one or more processors to provide input data to one or more machine-learning models to generate output data. The input data includes an input value for each of N features associated with an operating state of a monitored asset, where N is an integer greater than or equal to two. The output data includes a predicted value of each of M features, where M is an integer greater than or equal to two. The instructions, when executed, further cause the one or more processors to determine M sets of feature relevance values including a set of feature relevance values for each of the M predicted values. A particular set of feature relevance values is associated with a particular predicted value, and each feature relevance value of the particular set of feature relevance values represents an estimate of a contribution of a respective one of the N input values to the particular predicted value. The instructions, when executed, also cause the one or more processors to aggregate, across the M sets of feature relevance values, feature relevance values for each of the N features to generate N aggregate feature relevance values. The instructions, when executed, further cause the one or more processors to characterize the operating state of the monitored asset based at least in part on the N aggregate feature relevance values.

According to another particular aspect, a non-transitory processor-readable storage device stores processor-executable instructions that are executable by one or more processors to perform operations including providing input data to one or more machine-learning models to generate output data. The input data includes an input value for each of N features associated with an operating state of a monitored asset, where N is an integer greater than or equal to two. The output data includes a predicted value of each of M features, where M is an integer greater than or equal to two. The operations also include determining M sets of feature relevance values including a set of feature relevance values for each of the M predicted values. A particular set of feature relevance values is associated with a particular predicted value, and each feature relevance value of the particular set of feature relevance values represents an estimate of a contribution of a respective one of the N input values to the particular predicted value. The operations also include aggregating, across the M sets of feature relevance values, feature relevance values for each of the N features to generate N aggregate feature relevance values. The operations further include characterizing the operating state of the monitored asset based at least in part on the N aggregate feature relevance values.

### BRIEF DESCRIPTION OF THE DRAWINGS

FIG. 1 is a block diagram illustrating a particular implementation of a system to characterize an operating state of one or more monitored assets based on feature relevance data.

FIG. 2A is a diagram illustrating aspects of the system of FIG. 1 according to a particular implementation.

FIG. 2B is a diagram illustrating aspects of the system of FIG. 1 according to another particular implementation.

FIG. 3 is a diagram illustrating additional aspects of the system of FIG. 1 according to a particular implementation.

FIG. 4 is a flowchart representing a method that may be initiated, performed, or controlled by the system of FIG. 1 or a portion there of, according to a particular implementation.

FIG. 5 illustrates an example of a computer system corresponding to, including, or included within the system of FIG. 1 according to particular implementations.

### DETAILED DESCRIPTION

Systems and methods are described that enable characterizing an operating state of one or more monitored assets based on feature relevance data. Feature relevance data indicates an estimate of a contribution of each of a set of input values to particular predicted values. For example, input data based on values of a first set of features can be provided as input to a behavior model, and the behavior model can generate predicted values of a second set of features based on the input data. In this example, the feature relevance data indicates a contribution of each of the first set of features to the determination of the values of the second set of features. While the predicted values of the second set of features can be used to characterize the operating state of the monitored assets, use of the feature relevance data alone, or in combination with the predicted values, to characterize the operating state of the monitored asset(s) may provide additional insights into the operating state. For example, the feature relevance data may be used to provide earlier detection or prediction of abnormal operating states than use of the predicted values alone. As another example, the feature relevance data may be used to detect operating states that would not be readily detected using the predicted values alone. As a result, a monitoring system using the feature relevance data may be more reliable and/or may provide earlier detection of particular operating states than a monitoring system that uses only predicted values from a behavior model for operating state characterization.

Particular aspects of the present disclosure are described below with reference to the drawings. In the description, common features are designated by common reference numbers throughout the drawings. As used herein, various terminology is used for the purpose of describing particular implementations only and is not intended to be limiting. For example, the singular forms “a,” “an,” and “the” are intended to include the plural forms as well, unless the context clearly indicates otherwise. Further the terms “comprise,” “comprises,” and “comprising” may be used interchangeably with “include,” “includes,” or “including.” Additionally, the term “wherein” may be used interchangeably with “where.” As used herein, “exemplary” may indicate an example, an implementation, and/or an aspect, and should not be construed as limiting or as indicating a preference or a preferred implementation.

As used herein, an ordinal term (e.g., “first,” “second,” “third,” “Kth,” etc.) used to modify an element, such as a structure, a component, an operation, etc., does not by itself indicate any priority or order of the element with respect to another element, but rather merely distinguishes the element from another element having a same name (but for use of the ordinal term). As used herein, the term “set” refers to a grouping of one or more elements, and the term “plurality” refers to multiple elements. Additionally, in some instances, an ordinal term herein may use a letter (e.g., “Kth”) to indicate an arbitrary or open-ended number of distinct elements (e.g., zero or more elements). Different letters (e.g., “J” and “K”) are used for ordinal terms that describe two or more different elements when no particular relationship among the number of each of the two or more different elements is specified. For example, unless defined otherwise in the text, J may be equal to K, J may be greater than K, or J may be less than K.

In the present disclosure, terms such as “determining,” “calculating,” “estimating,” “shifting,” “adjusting,” etc. may be used to describe how one or more operations are performed. Such terms are not to be construed as limiting and other techniques may be utilized to perform similar operations. Additionally, as referred to herein, “generating,” “calculating,” “estimating,” “using,” “selecting,” “accessing,” and “determining” may be used interchangeably. For example, “generating,” “calculating,” “estimating,” or “determining” a parameter (or a signal) may refer to actively generating, estimating, calculating, or determining the parameter (or the signal) or may refer to using, selecting, or accessing the parameter (or signal) that is already generated, such as by another component or device.

As used herein, “coupled” may include “communicatively coupled,” “electrically coupled,” or “physically coupled,” and may also (or alternatively) include any combinations thereof. Two devices (or components) may be coupled (e.g., communicatively coupled, electrically coupled, or physically coupled) directly or indirectly via one or more other devices, components, wires, buses, networks (e.g., a wired network, a wireless network, or a combination thereof), etc. Two devices (or components) that are electrically coupled may be included in the same device or in different devices and may be connected via electronics, one or more connectors, or inductive coupling, as illustrative, non-limiting examples. In some implementations, two devices (or components) that are communicatively coupled, such as in electrical communication, may send and receive electrical signals (digital signals or analog signals) directly or indirectly, such as via one or more wires, buses, networks, etc. As used herein, “directly coupled” may include two devices that are coupled (e.g., communicatively coupled, electrically coupled, or physically coupled) without intervening components.

As used herein, the term “machine learning” should be understood to have any of its usual and customary meanings within the fields of computer science and data science, such meanings including, for example, processes or techniques by which one or more computers can learn to perform some operation or function without being explicitly programmed to do so. As a typical example, machine learning can be used to enable one or more computers to analyze data to identify patterns in data and generate a result based on the analysis. For certain types of machine learning, the results that are generated include data that indicates an underlying structure or pattern of the data itself. Such techniques, for example, include so called “clustering” techniques, which identify clusters (e.g., groupings of data elements of the data).

For certain types of machine learning, the results that are generated include a data model (also referred to as a “machine-learning model” or simply a “model”). Typically, a model is generated using a first data set to facilitate analysis of a second data set. For example, a first portion of a large body of data may be used to generate a model that can be used to analyze the remaining portion of the large body of data. As another example, a set of historical data can be used to generate a model that can be used to analyze future data.

Since a model can be used to evaluate a set of data that is distinct from the data used to generate the model, the model can be viewed as a type of software (e.g., instructions, parameters, or both) that is automatically generated by the computer(s) during the machine learning process. As such, the model can be portable (e.g., can be generated at a first computer, and subsequently moved to a second computer for further training, for use, or both). Additionally, a model can be used in combination with one or more other models to perform a desired analysis. To illustrate, first data can be provided as input to a first model to generate first model output data, which can be provided (alone, with the first data, or with other data) as input to a second model to generate second model output data indicating a result of a desired analysis. Depending on the analysis and data involved, different combinations of models may be used to generate such results. In some examples, multiple models may provide model output that is input to a single model. In some examples, a single model provides model output to multiple models as input.

Examples of machine-learning models include, without limitation, perceptrons, neural networks, support vector machines, regression models, decision trees, Bayesian models, Boltzmann machines, adaptive neuro-fuzzy inference systems, as well as combinations, ensembles and variants of these and other types of models. Variants of neural networks include, for example and without limitation, prototypical networks, autoencoders, transformers, self-attention networks, convolutional neural networks, deep neural networks, deep belief networks, etc. Variants of decision trees include, for example and without limitation, random forests, boosted decision trees, etc.

Since machine-learning models are generated by computer(s) based on input data, machine-learning models can be discussed in terms of at least two distinct time windows—a creation/training phase and a runtime phase. During the creation/training phase, a model is created, trained, adapted, validated, or otherwise configured by the computer based on the input data (which in the creation/training phase, is generally referred to as “training data”). Note that the trained model corresponds to software that has been generated and/or refined during the creation/training phase to perform particular operations, such as classification, prediction, encoding, or other data analysis or data synthesis operations. During the runtime phase (or “inference” phase), the model is used to analyze input data to generate model output. The content of the model output depends on the type of model. For example, a model can be trained to perform classification tasks or regression tasks, as non-limiting examples. In some implementations, a model may be continuously, periodically, or occasionally updated, in which case training time and runtime may be interleaved or one version of the model can be used for inference while a copy is updated, after which the updated copy may be deployed for inference.

In some implementations, a previously generated model is trained (or re-trained) using a machine-learning technique. In this context, “training” refers to adapting the model or parameters of the model to a particular data set. Unless otherwise clear from the specific context, the term “training” as used herein includes “re-training” or refining a model for a specific data set. For example, training may include so called “transfer learning.” As described further below, in transfer learning a base model may be trained using a generic or typical data set, and the base model may be subsequently refined (e.g., re-trained or further trained) using a more specific data set.

A data set used during training is referred to as a “training data set” or simply “training data”. The data set may be labeled or unlabeled. “Labeled data” refers to data that has been assigned a categorical label indicating a group or category with which the data is associated, and “unlabeled data” refers to data that is not labeled. Typically, “supervised machine-learning processes” use labeled data to train a machine-learning model, and “unsupervised machine-learning processes” use unlabeled data to train a machine-learning model; however, it should be understood that a label associated with data is itself merely another data element that can be used in any appropriate machine-learning process. To illustrate, many clustering operations can operate using unlabeled data; however, such a clustering operation can use labeled data by ignoring labels assigned to data or by treating the labels the same as other data elements.

Machine-learning models can be initialized from scratch (e.g., by a user, such as a data scientist) or using a guided process (e.g., using a template or previously built model). Initializing the model includes specifying parameters and hyperparameters of the model. “Hyperparameters” are characteristics of a model that are not modified during training, and “parameters” of the model are characteristics of the model that are modified during training. The term “hyperparameters” may also be used to refer to parameters of the training process itself, such as a learning rate of the training process. In some examples, the hyperparameters of the model are specified based on the task the model is being created for, such as the type of data the model is to use, the goal of the model (e.g., classification, regression, anomaly detection), etc. The hyperparameters may also be specified based on other design goals associated with the model, such as a memory footprint limit, where and when the model is to be used, etc.

Model type and model architecture of a model illustrate a distinction between model generation and model training. The model type of a model, the model architecture of the model, or both, can be specified by a user or can be automatically determined by a computing device. However, neither the model type nor the model architecture of a particular model is changed during training of the particular model. Thus, the model type and model architecture are hyperparameters of the model and specifying the model type and model architecture is an aspect of model generation (rather than an aspect of model training). In this context, a “model type” refers to the specific type or sub-type of the machine-learning model. As noted above, examples of machine-learning model types include, without limitation, perceptrons, neural networks, support vector machines, regression models, decision trees, Bayesian models, Boltzmann machines, adaptive neuro-fuzzy inference systems, as well as combinations, ensembles and variants of these and other types of models. In this context, “model architecture” (or simply “architecture”) refers to the number and arrangement of model components, such as nodes or layers, of a model, and which model components provide data to or receive data from other model components. As a non-limiting example, the architecture of a neural network may be specified in terms of nodes and links. To illustrate, a neural network architecture may specify the number of nodes in an input layer of the neural network, the number of hidden layers of the neural network, the number of nodes in each hidden layer, the number of nodes of an output layer, and which nodes are connected to other nodes (e.g., to provide input or receive output). As another non-limiting example, the architecture of a neural network may be specified in terms of layers. To illustrate, the neural network architecture may specify the number and arrangement of specific types of functional layers, such as long-short-term memory (LSTM) layers, fully connected (FC) layers, convolution layers, etc. While the architecture of a neural network implicitly or explicitly describes links between nodes or layers, the architecture does not specify link weights. Rather, link weights are parameters of a model (rather than hyperparameters of the model) and are modified during training of the model.

In many implementations, a data scientist selects the model type before training begins. However, in some implementations, a user may specify one or more goals (e.g., classification or regression), and automated tools may select one or more model types that are compatible with the specified goal(s). In such implementations, more than one model type may be selected, and one or more models of each selected model type can be generated and trained. A best performing model (based on specified criteria) can be selected from among the models representing the various model types. Note that in this process, no particular model type is specified in advance by the user, yet the models are trained according to their respective model types. Thus, the model type of any particular model does not change during training.

Similarly, in some implementations, the model architecture is specified in advance (e.g., by a data scientist); whereas in other implementations, a process that both generates and trains a model is used. Generating (or generating and training) the model using one or more machine-learning techniques is referred to herein as “automated model building”. In one example of automated model building, an initial set of candidate models is selected or generated, and then one or more of the candidate models are trained and evaluated. In some implementations, after one or more rounds of changing hyperparameters and/or parameters of the candidate model(s), one or more of the candidate models may be selected for deployment (e.g., for use in a runtime phase).

Certain aspects of an automated model building process may be defined in advance (e.g., based on user settings, default values, or heuristic analysis of a training data set) and other aspects of the automated model building process may be determined using a randomized process. For example, the architectures of one or more models of the initial set of models can be determined randomly within predefined limits. As another example, a termination condition may be specified by the user or based on configuration settings. The termination condition indicates when the automated model building process should stop. To illustrate, a termination condition may indicate a maximum number of iterations of the automated model building process, in which case the automated model building process stops when an iteration counter reaches a specified value. As another illustrative example, a termination condition may indicate that the automated model building process should stop when a reliability metric associated with a particular model satisfies a threshold. As yet another illustrative example, a termination condition may indicate that the automated model building process should stop if a metric that indicates improvement of one or more models over time (e.g., between iterations) satisfies a threshold. In some implementations, multiple termination conditions, such as an iteration count condition, a time limit condition, and a rate of improvement condition can be specified, and the automated model building process can stop when one or more of these conditions is satisfied.

Another example of training a previously generated model is transfer learning. “Transfer learning” refers to initializing a model for a particular data set using a model that was trained using a different data set. For example, a “general purpose” model can be trained to detect anomalies in vibration data associated with a variety of types of rotary equipment, and the general-purpose model can be used as the starting point to train a model for one or more specific types of rotary equipment, such as a first model for generators and a second model for pumps. As another example, a general-purpose natural-language processing model can be trained using a large selection of natural-language text in one or more target languages. In this example, the general-purpose natural-language processing model can be used as a starting point to train one or more models for specific natural-language processing tasks, such as translation between two languages, question answering, or classifying the subject matter of documents. Often, transfer learning can converge to a useful model more quickly than building and training the model from scratch.

Training a model based on a training data set generally involves changing parameters of the model with a goal of causing the output of the model to have particular characteristics based on data input to the model. To distinguish from model generation operations, model training may be referred to herein as optimization or optimization training. In this context, “optimization” refers to improving a metric, and does not mean finding an ideal (e.g., global maximum or global minimum) value of the metric. Examples of optimization trainers include, without limitation, backpropagation trainers, derivative free optimizers (DFOs), and extreme learning machines (ELMs). As one example of training a model, during supervised training of a neural network, an input data sample is associated with a label. When the input data sample is provided to the model, the model generates output data, which is compared to the label associated with the input data sample to generate an error value. Parameters of the model are modified in an attempt to reduce (e.g., optimize) the error value. As another example of training a model, during unsupervised training of an autoencoder, a data sample is provided as input to the autoencoder, and the autoencoder reduces the dimensionality of the data sample (which is a lossy operation) and attempts to reconstruct the data sample as output data. In this example, the output data is compared to the input data sample to generate a reconstruction loss, and parameters of the autoencoder are modified in an attempt to reduce (e.g., optimize) the reconstruction loss.

As another example, to use supervised training to train a model to perform a classification task, each data element of a training data set may be labeled to indicate a category or categories to which the data element belongs. In this example, during the creation/training phase, data elements are input to the model being trained, and the model generates output indicating categories to which the model assigns the data elements. The category labels associated with the data elements are compared to the categories assigned by the model. The computer modifies the model until the model accurately and reliably (e.g., within some specified criteria) assigns the correct labels to the data elements. In this example, the model can subsequently be used (in a runtime phase) to receive unknown (e.g., unlabeled) data elements, and assign labels to the unknown data elements. In an unsupervised training scenario, the labels may be omitted. During the creation/training phase, model parameters may be tuned by the training algorithm in use such that during the runtime phase, the model is configured to determine which of multiple unlabeled “clusters” an input data sample is most likely to belong to.

As another example, to train a model to perform a regression task, during the creation/training phase, one or more data elements of the training data are input to the model being trained, and the model generates output indicating a predicted value of one or more other data elements of the training data. The predicted values of the training data are compared to corresponding actual values of the training data, and the computer modifies the model until the model accurately and reliably (e.g., within some specified criteria) predicts values of the training data. In this example, the model can subsequently be used (in a runtime phase) to receive data elements and predict values that have not been received. To illustrate, the model can analyze time series data, in which case, the model can predict one or more future values of the time series based on one or more prior values of the time series.

In some aspects, the output of a model can be subjected to further analysis operations to generate a desired result. To illustrate, in response to particular input data, a classification model (e.g., a model trained to perform classification tasks) may generate output including an array of classification scores, such as one score per classification category that the model is trained to assign. Each score is indicative of a likelihood (based on the model's analysis) that the particular input data should be assigned to the respective category. In this illustrative example, the output of the model may be subjected to a softmax operation to convert the output to a probability distribution indicating, for each category label, a probability that the input data should be assigned the corresponding label. In some implementations, the probability distribution may be further processed to generate a one-hot encoded array. In other examples, other operations that retain one or more category labels and a likelihood value associated with each of the one or more category labels can be used.

One example of a machine-learning model is an autoencoder. An autoencoder is a particular type of neural network that is trained to receive multivariate input data, to process at least a subset of the multivariate input data via one or more hidden layers, and to perform operations to reconstruct the multivariate input data using output of the hidden layers. If at least one hidden layer of an autoencoder includes fewer nodes than the input layer of the autoencoder, the autoencoder may be referred to herein as a dimensional reduction model. If each of the one or more hidden layer(s) of the autoencoder includes more nodes than the input layer of the autoencoder, the autoencoder may be referred to herein as a denoising model or a sparse model, as explained further below.

For dimensional reduction type autoencoders, the hidden layer with the fewest nodes is referred to as the latent space layer. Thus, a dimensional reduction autoencoder is trained to receive multivariate input data, to perform operations to dimensionally reduce the multivariate input data to generate latent space data in the latent space layer, and to perform operations to reconstruct the multivariate input data using the latent space data. “Dimensional reduction” in this context refers to representing j values of multivariate input data using z values (e.g., as latent space data), where j and z are integers and z is less than j. Often, in an autoencoder the z values of the latent space data are then dimensionally expanded to generate j values of output data. In some special cases, a dimensional reduction model may generate l values of output data, where l is an integer that is not equal to j. As used herein, such special cases are still referred to as autoencoders as long as the data values represented by the input data are a subset of the data values represented by the output data or the data values represented by the output data are a subset of the data values represented by the input data. For example, if the multivariate input data includes 10 sensor data values from 10 sensors, and the dimensional reduction model is trained to generate output data representing only 5 sensor data values corresponding to 5 of the 10 sensors, then the dimensional reduction model is referred to herein as an autoencoder. As another example, if the multivariate input data includes 10 sensor data values from 10 sensors, and the dimensional reduction model is trained to generate output data representing 10 sensor data values corresponding to the 10 sensors and to generate a variance value (or other statistical metric) for each of the sensor data values, then the dimensional reduction model is also referred to herein as an autoencoder (e.g., a variational autoencoder).

Denoising autoencoders and sparse autoencoders are examples of autoencoders that do not include a latent space layer to force changes in the input data. An autoencoder without a latent space layer could simply pass the input data, unchanged, to the output nodes resulting in a model with little utility. As one example, some denoising autoencoders avoid this result by zeroing out a subset of values of an input data set while training the denoising autoencoder to reproduce the entire input data set at the output nodes. Put another way, such denoising autoencoders are trained to reproduce an entire input data sample based on input data that includes less than the entire input data sample. For example, during training of a denoising autoencoder that includes 10 nodes in the input layer and 10 nodes in the output layer, a single set of input data values includes 10 data values (which generally include an added noise term); however, only a subset of the 10 data values (e.g., between 2 and 9 data values) are provided to the input layer. The remaining data values are zeroed out. To illustrate, out of 10 data values, 7 data values may be provided to a respective 7 nodes of the input layer, and zero values may be provided to the other 3 nodes of the input layer. Fitness of the denoising autoencoder is evaluated based on how well the output layer reproduces all 10 data values of the set of input data values, and during training, parameters of the denoising autoencoder are modified over multiple iterations to improve its fitness.

Sparse autoencoders prevent passing the input data unchanged to the output nodes by selectively activating a subset of nodes of one or more of the hidden layers of the sparse autoencoder. For example, if a particular hidden layer has 10 nodes, only 3 nodes may be activated for particular data. The sparse autoencoder is trained such that which nodes are activated is data dependent. For example, for a first data sample, 3 nodes of the particular hidden layer may be activated, whereas for a second data sample, 5 nodes of the particular hidden layer may be activated.

One use case for autoencoders is detecting significant changes in data. For example, an autoencoder can be trained using training sensor data gathered while a monitored system is operating in a first operational mode. In this example, after the autoencoder is trained, real-time sensor data from the monitored system can be provided as input data to the autoencoder. If the real-time sensor data is sufficiently similar to the training sensor data, then the output of the autoencoder should be similar to the input data. Illustrated mathematically:

$$- {x}_{k} \approx 0$$

where [symbol] represents an output data value k and xₖ represents the input data value k. If the output of the autoencoder exactly reproduces the input, then [symbol] −xₖ=0 for each data value k. However, it is generally the case that the output of a well-trained autoencoder is not identical to the input. In such cases, [symbol] −xₖ=rₖ, where rₖ represents a residual value. Residual values that result when particular input data is provided to the autoencoder can be used to determine whether the input data is similar to training data used to train the autoencoder. For example, when the input data is similar to the training data, relatively small residual values should result. In contrast, when the input data is not similar to the training data, relatively large residual values should result. During runtime operation, residual values calculated based on output of the autoencoder can be used to determine the likelihood or risk that the input data differs significantly from the training data.

As one particular example, the input data can include multivariate sensor data representing operation of a monitored system. In this example, the autoencoder can be trained using training data gathered while the monitored system was operating in a first operational mode (e.g., a normal mode or some other mode). During use, real-time sensor data from the monitored system can be input to the autoencoder, and residual values can be determined based on differences between the real-time sensor data and output data from the autoencoder. If the monitored system transitions to a second operational mode (e.g., an abnormal mode, a second normal mode, or some other mode) statistical properties of the residual values (e.g., the mean or variance of the residual values over time) will change. Detection of such changes in the residual values can provide an early indication of changes associated with the monitored system. To illustrate, one use of the example above is early detection of abnormal operation of the monitored system. In this use case, the training data includes a variety of data samples representing one or more “normal” operating modes. During runtime, the input data to the autoencoder represents the current (e.g., real-time) sensor data values, and the residual values generated during runtime are used to detect early onset of an abnormal operating mode. In other use cases, autoencoders can be trained to detect changes between two or more different normal operating modes (in addition to, or instead of, detecting onset of abnormal operating modes).

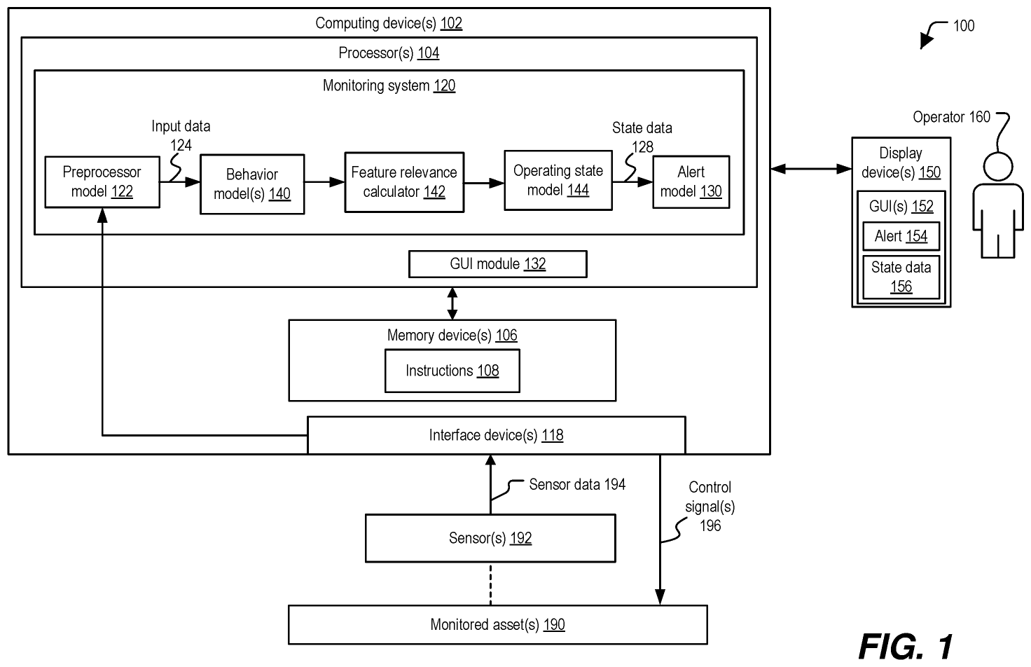

FIG. 1 is a block diagram illustrating a particular implementation of a system 100 that is configured to characterize an operating state of one or more monitored assets 190 based on feature relevance data. The system 100 includes one or more computing devices 102 configured to monitor operation of the monitored asset(s) 190 based on sensor data 194 from one or more sensors 192 associated with the monitored asset(s) 190. In a particular implementation, the computing device(s) 102 are configured to generate one or more control signals 196 to modify or control operation of the monitored asset(s) 190 based on analysis of the sensor data 194 (e.g., based on an operating state of the monitored asset(s) 190). In this context, a “monitored asset” refers to one or more devices, one or more systems, or one or more processes that are monitored, via the sensor(s) 192, such as to detect or predict an operating state of the monitored asset, to detect or predict abnormal behavior of the monitored asset, etc. To illustrate, the monitored asset(s) 190 may include one or more mechanical devices, one or more electromechanical devices, one or more electrical devices, one or more electronic devices, or various combinations thereof.

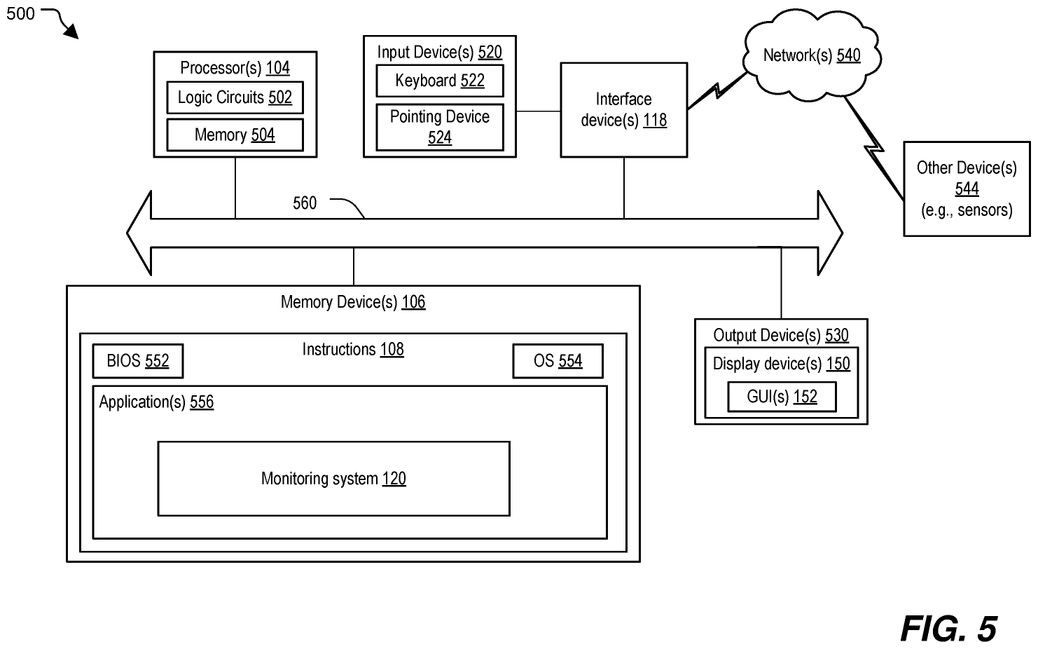

In the example illustrated in FIG. 1, the computing device(s) 102 include one or more memory devices 106, one or more processors 104, and one or more interface devices 118. In other examples, the computing device(s) 102 include more, fewer, or different components. To illustrate, FIG. 5 shows an example of a computing device that includes additional components.

The interface device(s) 118 are configured to receive the sensor data 194 from the sensor(s) 192. In an example, the interface device(s) 118 include or correspond to bus interface(s), wireline network interface(s), wireless network interface(s), or one or more other interfaces or circuits configured to receive the sensor data 194 via wireless transmission, via wireline transmission, or any combination thereof. Although FIG. 1 illustrates the sensor(s) 192 sending the sensor data 194 directly to the interface device(s) 118, in other implementations, the sensor(s) 192 provide the sensor data 194 to one or more intermediate devices (e.g., local controllers, centralized control systems, routers, switches, storage devices, servers, etc.), and the interface device(s) 118 obtain the sensor data 194 from the intermediate device(s).

In various implementations, the processor(s) 104 include one or more single-core or multi-core processing units, one or more digital signal processors (DSPs), one or more graphics processing units (GPUs), or any combination thereof. Further, in various implementations, the memory device(s) 106 include volatile memory devices, non-volatile memory devices, or both, such as one or more hard drives, solid-state storage devices (e.g., flash memory, magnetic memory, or phase change memory), a random access memory (RAM), a read-only memory (ROM), one or more other types of processor-readable storage devices, or any combination thereof.

The memory device(s) 106 store instructions 108 that are executable by the processor(s) 104 to initiate, perform, or control various operations, such as operations associated with a monitoring system 120. For example, the instructions 108 may be executable to generate input data 124 based on the sensor data 194 and determine state data 128 indicating an operating state (e.g., a prior, current, or predicted future operating state) of the monitored asset(s) 190, as described further below. In particular examples, the state data 128 may identify a particular operating state of the monitored asset(s) 190 or may identify a class (e.g., normal or anomalous) associated with the particular operating state of the monitored asset(s) 190. In some implementations, an alert model 130 of the monitoring system 120 is configured to determine whether to generate an alert 154 based on the state data 128. For example, when the state data 128 satisfies particular alert conditions, the alert model 130 may cause a graphical-user interface (GUI) module 132 of the computing device(s) 102 to send one or more GUIs 152 to one or more display devices 150 coupled to the computing device(s) 102. In this example, the GUI(s) 152 may include the alert 154. Additionally, or alternatively, the GUI(s) 152 may include state data 156 corresponding to or including the state data 128. The GUI(s) 152 enable an operator 160 associated with the computing device(s) 102 and/or the monitored asset(s) 190 to take appropriate action based on the state data 156. Thus, the computing device(s) 102 use the instructions 108 to perform real-time or near real-time monitoring of the monitored asset(s) 190 based on the sensor data 194.

In some implementations, the monitoring system 120 is configured to detect anomalous behavior of one or more of the monitored asset(s) 190. In some implementations, the monitoring system 120 is configured to distinguish between two or more abnormal (e.g., anomalous) operational states of the monitored asset(s) 190. In some implementations, the monitoring system 120 is configured to distinguish between two or more normal (e.g., non-anomalous) operational states of the monitored asset(s) 190. In some implementations, the monitoring system 120 is configured to perform two or more of detecting anomalous behavior, distinguishing between two or more abnormal operational states, and distinguishing between two or more normal operational states of the monitored asset(s) 190.

During operation, the sensor(s) 192 generate the sensor data 194 by measuring physical characteristics, chemical characteristics, electromagnetic characteristics, radiologic characteristics, or other measurable characteristics. Different sensors may have different sample rates. One or more of the sensor(s) 192 may generate sensor data samples periodically (e.g., with regularly spaced sampling periods), and one or more others of the sensor(s) 192 may generate sensor data samples occasionally (e.g., whenever a state change occurs).

In a particular implementation, each sensor generates a time series of measurements. The time series from each sensor represents a corresponding feature. As used herein, a “feature” associated with one of the monitored asset(s) 190 is an individual property or characteristic that can be measured, inferred, or calculated and that is representative of operation of the monitored asset 190. Non-limiting examples of the features include values of control variables associated with the monitored asset(s) 190 (e.g., state values, such as valve position), values of the sensor data 194, and values calculated or inferred based on the sensor data 194.

A preprocessor model 122 (also referred to as a “data preprocessing model”) receives the sensor data 194 for a particular timeframe. During some timeframes, the sensor data 194 for the particular timeframe may include a single data sample for each of one or more of the features. During some timeframes, the sensor data 194 for the particular timeframe may include multiple data samples for one or more of the features. During some timeframes, the sensor data 194 for the particular timeframe may include no data samples for one or more of the features. In a particular example, the sensor(s) 192 include a first sensor that only registers state changes (e.g., on/off state changes), a second sensor that generates a data sample once per second, and a third sensor that generates 10 data samples per second, and the preprocessor model 122 processes one-second timeframes. In this particular example, for a particular one-second timeframe, the preprocessor model 122 may receive sensor data 194 that includes no data samples from the first sensor (e.g. if no state change occurred), one data sample from the second sensor, and ten data samples from the third sensor. Other combinations of sampling rates and preprocessing timeframes are used in other examples.

The preprocessor model 122 generates the input data 124 for the behavior model(s) 140 based on the sensor data 194. For example, the preprocessor model 122 may resample the sensor data 194, may filter the sensor data 194, may impute data, may use the sensor data 194 (and possibly other data) to generate new feature data values, may perform other preprocessing operations, or a combination thereof.

In the example illustrated in FIG. 1, the monitoring system 120 includes the behavior model(s) 140, a feature relevance calculator 142, and an operating state model 144. In other examples, the monitoring system 120 includes more, fewer, or different machine-learning based models or calculation modules. For example, in some implementations, the monitoring system 120 may include a plurality of behavior models, a plurality of feature relevance calculators, and/or a plurality of operating state models. To illustrate, when the monitored asset(s) 190 include two distinct devices, the monitoring system 120 may include two behavior models (e.g., one behavior model for each of the two distinct devices), two feature importance calculators (e.g., one feature importance calculator for each of the two distinct devices), and two operating state models (e.g., one operating state model for each of the two distinct devices). In another illustrative example, the monitoring system 120 may include two or more behavior models for a single monitored asset 190, may include two or more feature relevance calculators for a single monitored asset 190, may include two or more operating state models for a single monitored asset 190, or any combination thereof.

The behavior model 140 is configured to receive the input data 124 representing a set of features associated with the monitored asset(s) 190 and to generate output data that includes a predicted value of one or more of the features. For example, the behavior model 140 may receive input data 124 representing N features and may generate output data representing predicted values of M features, where N and M are each integers greater than two. In this example, N may be greater than M, equal to M, or less than M.

In various non-limiting examples, the behavior model 140 includes an autoencoder, a time series predictor, a feature predictor, or a combination thereof. In an implementation in which the behavior model 140 includes an autoencoder, the autoencoder may include or correspond to a dimensional-reduction type autoencoder, a denoising autoencoder, or a sparse autoencoder. Additionally, the autoencoder may have a symmetric architecture (e.g., an encoder portion of the autoencoder and a decoder portion of the autoencoder have mirror-image architectures) or a non-symmetric architecture (e.g., the encoder portion has a different number, type, size, or arrangement of layers than the decoder portion). When the behavior model 140 includes an autoencoder, the autoencoder is trained to receive data representing values of N features as input and to generate data representing values of M features as output, where the M features are the same as the N features or the M features are a subset of the N features.

In an implementation in which the behavior model 140 includes a time series predictor, the time series predictor includes or corresponds to one or more neural networks trained to forecast future data values. For example, the time series predictor is trained to receive values of N features for a particular timeframe as the input data 124 and to estimate or predict future values of M features for a subsequent timeframe as output, where the M features are the same as the N features or the M features are a subset of the N features.

In an implementation in which the behavior model 140 includes a feature predictor, the feature predictor includes or corresponds to one or more neural networks trained to predict data values based on other data values. For example, the feature predictor is trained to receive values of N features as input data and to estimate or predict values of M features as output, where at least one of the M features is not included in the N features of the input data.

The feature relevance calculator 142 is configured to determine aggregate feature relevance values for each of the input feature data values. To illustrate, when the input data includes values for N features, the feature relevance calculator 142 is configured to determine N aggregate feature relevance values. As used herein, a “feature relevance value” indicates an estimate of a contribution of a particular input feature to a predicted value of an output feature. In some implementations, a feature relevance value is calculated for each output feature value. As a result, each input feature value may be associated with more than one feature relevance value. In such implementations, the feature relevance values of an input feature are aggregated to make a single aggregate feature relevance value for the input feature.

The operating state model 144 is configured to generate the state data 128 based on operating state input data that includes the feature relevance values. In some implementations, the operating state input data includes the feature relevance values and output data from the behavior model 140. In some implementations, the operating state model 144 includes or corresponds to a neural network that is trained to classify the operating state of the monitored asset(s) 190 based on the operating state input data (e.g., based on the feature relevance values or based on the feature relevance values and output data from the behavior model 140). In some implementations, the operating state model 144 includes or corresponds to an operating state score calculator. In such implementations, the operating state model 144 is configured to determine an operating state score for each sample timeframe of the operating state input data. The operating state score indicates a likelihood that the operating state input data is indicative of operation of the monitored asset(s) 190 in a particular operating state. As one example, the operating state model 144 is configured to distinguish between normal and anomalous operating states. In this example the operating state score is an anomaly score indicating a likelihood that the operating state input data indicates anomalous operation of the monitored asset(s) 190. In some implementations, the operating state score is calculated based on or is equal to a value of a risk index. To illustrate, the risk index may be calculated as an L1- or L2-norm of a rolling mean of the feature relevance values. In another non-limiting example, the risk index is calculated as a rolling mean of L1- or L2-norms of the feature relevance values. In some implementations, the operating state score is calculated based on or is equal to a value of a feature importance score. In a particular example, the feature importance score is calculated as a rolling mean of the absolute value of the feature relevance values. In still other implementations, the feature relevance values and values based on the output data from the behavior model 140 are used together to determine the operating state score.

In a particular implementation, the state data 128, which is based on or indicates the operating state scores may be provided to the alert model 130 to determine whether to generate the alert 154. As an example, the alert model 130 compares one or more values of the state data 128 to one or more respective thresholds to determine whether to generate the alert 154. The respective threshold(s) may be preconfigured or determined dynamically (e.g., based on one or more values of the sensor data 194, one or more values of the input data 124, etc.). In a particular implementation, the alert model 130 determines whether to generate the alert 154 using a sequential probability ratio test (SPRT) based on current values of the state data 128 and historical values of the state data 128.

Although FIG. 1 depicts the display device(s) 150 as coupled to the computing device(s) 102, in other implementations one or more of the display device(s) 150 are integrated within one or more of the computing device(s) 102. Although FIG. 1 illustrates the alert 154 being presented to the operator 160 via the display device(s) 150, in other implementations the alert 154 may alternatively, or additionally, be provided via one or more other mechanisms, such as an output interface that includes at least one of a light, a buzzer, a sound, or a signal port. In some implementations, functionality corresponding to the sensor(s) 192 and the computing device(s) 102 are integrated into a single device, such as within a common housing. Although FIG. 1 depicts the sensor(s) 192 as external to the monitored asset(s) 190, in other implementations one or more of the sensor(s) 192 may be integrated in the monitored asset(s) 190.

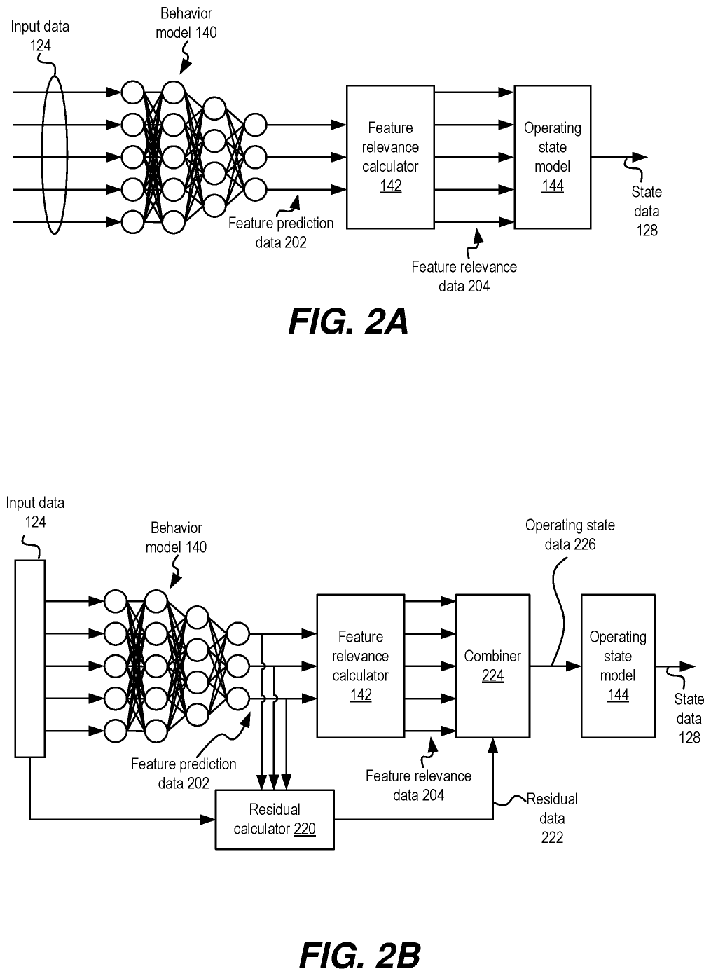

FIGS. 2A and 2B are diagrams illustrating aspects of the system 100 of FIG. 1 according to particular implementations. In particular, FIGS. 2A and 2B illustrate examples of the input data 124, the behavior model(s) 140, the feature relevance calculator 142, the operating state model 144, and the state data 128. In each of FIGS. 2A and 2B, the behavior model 140 is illustrated as a neural network merely as one example. The specific arrangement of nodes, layers, and interconnections of the behavior model 140 shown in FIGS. 2A and 2B is merely for illustration and is not limiting. For example, the behavior model 140 of FIGS. 2A and 2B is shown as a simple feedforward network with an input layer, two hidden layers, and an output layer, and each layer is illustrated as a fully connected layer. However, in other examples, the behavior model 140 may include more, fewer, or different types of layers. To illustrate, in some implementations, the behavior model 140 may include one or more recurrent layers and/or one or more convolutional layers, one or more softmax layers, etc. Further, the layers of the behavior model 140 may be arranged in a different manner. To illustrate, in some implementations, the behavior model 140 includes a dimensional-reduction autoencoder.

In each of FIGS. 2A and 2B, the behavior model 140 is configured to receive the input data 124. In the example illustrated in FIGS. 2A and 2B, the input data 124 includes multiple features (represented by multiple arrows), each of which is provided to a respective input node of the behavior model 140. In the specific example of FIGS. 2A and 2B, the behavior model 140 includes five input nodes to receive values of five features; however, more generally, the input data 124 includes N values corresponding to N features, where N is an integer greater than or equal to two.

The behavior model 140 is configured to process the input data 124 associated with a particular timeframe (e.g., one set of N feature data values representing one sample period) to generate feature prediction data 202. In the specific example of FIGS. 2A and 2B, the behavior model 140 includes three output nodes to output three feature prediction data values; however, more generally, the feature prediction data 202 includes M values corresponding to M features, where M is an integer greater than or equal to two.

In some implementations, the count of features of the input data 124 is equal to the count of features of the feature prediction data 202 (i.e., N is equal to M). To illustrate, when the behavior model 140 is an autoencoder, the behavior model 140 may be configured to receive input data 124 that includes twelve features. In this example, the autoencoder may dimensionally reduce the input data 124 to a latent space that includes fewer than twelve nodes, and then attempt to recreate the twelve features, which results in feature prediction data 202 including predicted values of the twelve features.

In some implementations, the count of features of the input data 124 is greater than the count of features of the feature prediction data 202 (i.e., N is greater than M). For example, the behavior model 140 may include a feature predictor that is trained to generate output data indicating predicted values of one or more features that were not provided to the behavior model 140 as part of the input data 124. To illustrate, the behavior model 140 may be configured to receive input data 124 that includes twelve features and to determine as output predicted values of five features, at least one of which was not provided as part of the input data 124.

In some implementations, the count of features of the input data 124 is less than the count of features of the feature prediction data 202 (i.e., N is less than M). For example, the behavior model 140 may include a feature predictor that is trained to generate output data indicating predicted values of one or more features that were not provided to the behavior model 140 as part of the input data 124. To illustrate, the behavior model 140 may be configured to receive input data 124 that includes ten features and to determine as output predicted values of eleven features, at least one of which was not provided as part of the input data 124.

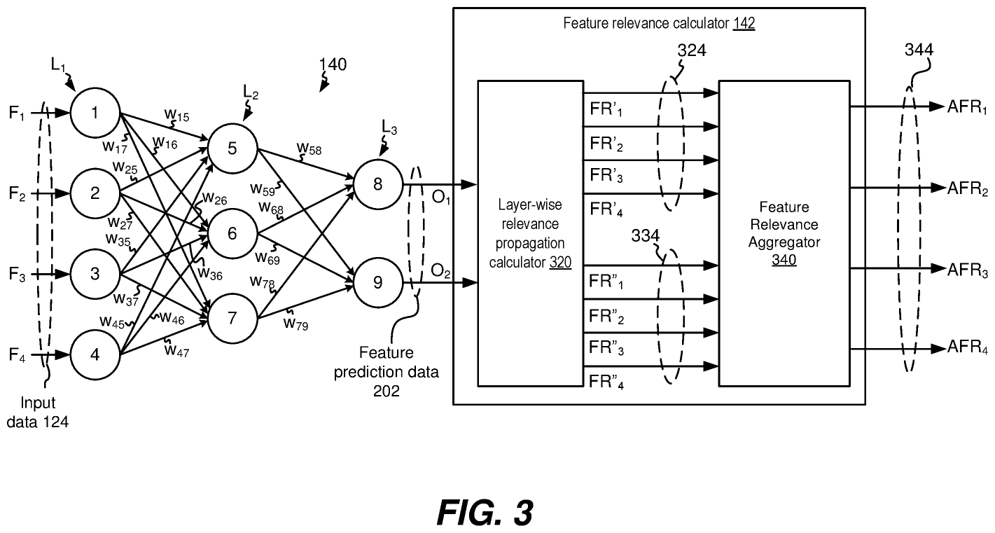

The feature prediction data 202 is provided as input to the feature relevance calculator 142. The feature relevance calculator 142 is configured to determine feature relevance data 204 based on the feature prediction data 202. The feature relevance data 204 includes the same number of values as the input data 124. To illustrate, when the input data 124 includes N values, the feature relevance data 204 includes N values. Each value of the feature relevance data 204 is indicative of a contribution of a particular input feature of the input data 124 to the predicted values of the feature prediction data 202, as explained further with reference to FIG. 3.

In the example illustrated in FIG. 2A, the feature relevance data 204 is provided as input to the operating state model 144 to generate the state data 128. In a particular implementation, the operating state model 144 includes a trained machine-learning model, such as a neural network, a decision tree, an ensemble, or a combination thereof. To illustrate, the operating state model 144 may include a classifier, in which case the state data 128 may indicate a particular class representing the operating state of the monitored asset(s) 190 or may include probabilities associated with a plurality of classes, where each class corresponds to a respective operating state of the monitored asset(s) 190.

In the example illustrated in FIG. 2B, one or more values of the feature relevance data 204 are provided as input to a residual calculator 220. The residual calculator 220 is configured to determine residual data 222 (e.g., one or more residual data values) based on the one or more values of the feature relevance data 204 and one or more values of the input data 124. In a particular implementation, the residual calculator 220 is configured to generate a residual value (denoted as r) based on a difference between a value of a particular feature of the feature prediction data 202 and a corresponding actual value of the particular feature from the input data 124. For example, when the model output is generated by an autoencoder, the residual can be determined according to r=z′ₜ−zₜ, where z′ₜ is an estimated value (from the feature prediction data 202) of a feature z for a particular time step (t) and zₜ is the actual value (from the input data 124) of the feature z for the particular time step (t). As another example, when the model output is generated by a time series predictor, the residual can be determined according to r=z′ₜ₊₁−zₜ₊₁, where z′ₜ₊₁ is an estimated value (from the feature prediction data 202) based on data for a prior time step (t) and zₜ₊₁ is the actual value (from the input data 124) of z for a later time step (t+1). As still another example, when the model output is generated by a feature predictor, the residual can be determined according to r=y′ₜ−yₜ, where y′ₜ is an estimated value (from the feature prediction data 202) based on a value of z for a particular time step (t) and yₜ is the actual value (from the input data 124) of y for the particular time step (t). Note that when a feature predictor is used, values of the predicted feature (e.g., y in the example above) are not provided as input to the behavior model 140; however, such values are provided as input to the residual calculator 220 to determine the residual data 222.

In FIG. 2B, the residual data 222 and the feature relevance data 204 are provided to a combiner 224 that is configured to combine the residual data 222 and the feature relevance data 204 to generate operating state data 226 that is provided to the operating state model 144. In a particular implementation, the combiner 224 uses an element-by-element operation to combine the residual data 222 and the feature relevance data 204. For example, a value of the feature relevance data 204 for a particular feature may be combined with a value of the residual data 222 for the particular feature. In some implementations, the residual data 222 and the feature relevance data 204 are combined mathematically, such as via an addition operation, a multiplication operation, or a more complex mathematical operation. In other implementations, the residual data 222 and the feature relevance data 204 are combined using a non-mathematical operation, such as concatenation.

The operating state model 144 of FIG. 2B may operate as described with reference to the operating state model 144 of FIG. 2A except that operating state model 144 of FIG. 2B uses the operating state data 226 to determine the state data 128. For example, the operating state model 144 of FIG. 2B may include a trained machine-learning model, such as a neural network, a decision tree, an ensemble, or a combination thereof, that is configured to generate the state data 128 based on the operating state data 226.

FIG. 3 is a diagram illustrating additional aspects of the system 100 of FIG. 1 according to a particular implementation. In particular, FIG. 3 illustrates an example of the behavior model 140 and an example of the feature relevance calculator 142. In FIG. 3, the behavior model 140 is represented as a neural network that includes a plurality of nodes (represented by circles in FIG. 3 and numbered sequentially from 1 to 9 for ease of reference). The nodes are arranged in a plurality of fully connected layers (labeled as layers L₁, L₂, and L₃ in FIG. 3). Each node-to-node link is associated with a corresponding link weight. In FIG. 3, the link weights are labeled w_{ab}, where a is an index indicating the upstream node of the link and b is an index indicating the downstream node of the link. For example, w₄₇ is a link weight of a link between node 4 and node 7. As explained above, the particular number of nodes, the particular number of layers, and/or the arrangement of interconnections between nodes is different in other implementations.

In FIG. 3, layer L₁ is an input layer of the behavior model 140, layer L₂ is a hidden layer of the behavior model 140, and layer L₃ is an output layer of the behavior model 140. The specific number of layers in FIG. 3 is merely for illustration and is not limiting. In other examples, the behavior model 140 includes more or fewer layers. Likewise, the arrangement of interconnections between the layers is merely for illustration and is not limiting. In other examples, the behavior model 140 includes one or more convolution layers and/or layers having other interconnection schemes.

In FIG. 3, the input layer (L₁) includes four nodes, including node 1, node 2, node 3, and node 4. Each node of the input layer is configured to receive input representing a value of a respective feature of the input data 124. For example, node 1 is configured to receive values of a first feature (labeled F₁), node 2 is configured to receive values of a second feature (labeled F₂), node 3 is configured to receive values of a third feature (labeled F₃), and node 4 is configured to receive values of a fourth feature (labeled F₄). The specific count of nodes of the input layer and the corresponding count of features of the input data 124 illustrated in FIG. 3 is merely one example. More generally, the input layer includes N nodes to receive values of N features of the input data 124, where N is an integer greater than or equal to two.

In FIG. 3, the output layer (L₃) includes two nodes, including node 8 and node 9. Each node of the output layer is configured to generate an output representing a value of a respective feature of the feature prediction data 202. For example, node 8 is configured to output a predicted value of a first feature (labeled O₁), and node 9 is configured to output a predicted value of a second feature (labeled O₂). The specific count of nodes of the output layer L₃ and the corresponding count of features of the feature prediction data 202 illustrated in FIG. 3 is merely one example. More generally, the output layer L₃ includes M nodes to generate predicted values of M features of the feature prediction data 202, where M is an integer greater than or equal to two.

In FIG. 3, the feature relevance calculator 142 is illustrated in multiple parts including a layer-wise relevance propagation calculator 320 and a feature relevance aggregator 340. The layer-wise relevance propagation calculator 320 is configured to perform layer-wise relevance propagation for each feature (O) of the feature prediction data 202. The feature relevance aggregator 340 is configured to generate a single aggregate feature relevance value (labeled AFR) corresponding to each feature (F) of the input data 124.

As an example of layer-wise relevance propagation performed by the layer-wise relevance propagation calculator 320, the layer-wise relevance propagation calculator 320 receives as input a predicted value of the first feature O₁, and calculates, based on the layers, interconnection scheme, link weights, and other parameters of the behavior model 140, a contribution of each of the features F₁-F₄ to the predicted value of the first feature O₁. In FIG. 3, the contribution of the first feature F₁ to the predicted value of the first feature O₁ is labeled FR′₁, the contribution of the first feature F₂ to the predicted value of the first feature O₁ is labeled FR′₂, the contribution of the third feature F₃ to the predicted value of the first feature O₁ is labeled FR′₃, and the contribution of the fourth feature F₄ to the predicted value of the first feature O₁ is labeled FR′₄. Together, the feature relevance values FR′₁, FR′₂, FR′₃, and FR′₄ comprise a first set of feature relevance values 324.

Similarly, the layer-wise relevance propagation calculator 320 receives as input a predicted value of the second feature O₂, and calculates, based on the layers, interconnection scheme, link weights, and other parameters of the behavior model 140, a contribution of each of the features F₁-F₄ to the predicted value of the second feature O₂. In FIG. 3, the contribution of the first feature F₁ to the predicted value of the second feature O₂ is labeled FR″₁, the contribution of the first feature F₂ to the predicted value of the second feature O₂ is labeled FR″₂, the contribution of the third feature F₃ to the predicted value of the second feature O₂ is labeled FR″₃, and the contribution of the fourth feature F₄ to the predicted value of the second feature O₂ is labeled FR″₄. Together, the feature relevance values FR″₁, FR″₂, FR″₃, and FR″₄ comprise a second set of feature relevance values 334.

The layer-wise relevance propagation calculations performed by the layer-wise relevance propagation calculator 320 can be viewed, for purposes of explanation, as working backward through the behavior model 140 from the output layer L₃ to the input layer L₁. Viewed in this manner, each value of the feature prediction data 202 is distributed to nodes of a prior layer as a relevance value associated with each node of the prior layer. The relevance values are distributed based on values of link weights between the layers and in a manner such that the sum of the relevance values for a particular layer is equal to the value of the feature prediction data 202 for which the layer-wise relevance propagation calculations are being performed.

For example, when calculating the first set of feature relevance values 324 associated with the predicted value of the first feature O₁, a relevance value is determined for each node of the hidden layer L₂ that is connected to node 8 of the output layer L₃. The relevance value of a particular node of the hidden layer L₂ is based on the link weight between the particular node and node 8. To illustrate, the relevance value for node 5 is based on the value of the first feature O₁ and the link weight w₅₈ between node 5 and node 8, the relevance value for node 6 is based on the value of the first feature O₁ and the link weight w₆₈ between node 6 and node 8, and the relevance value for node 7 is based on the value of the first feature O₁ and the link weight w₇₈ between node 7 and node 8. Further, a sum of the relevance value for node 5, the relevance value for node 6, and the relevance value for node 7 is equal to the predicted value of the first feature O₁.

Similar operations are performed to apportion relevance to the next prior layer (e.g., L₁ in the example illustrated in FIG. 3) except that nodes of the next prior layer may be connected to more than one node from which relevance is to be distributed. To illustrate, each node of the layer L₂ is only connected to one node (i.e., node 8) from which relevance associated with the predicted value of the first feature O₁ is to be apportioned. However, in the example of FIG. 3, each node of the layer L₁ is connected to each node of the layer L₂, and each node of the layer L₂ is associated with a respective relevance based on the predicted value of the first feature O₁. Accordingly. the relevance assigned to each node of the layer L₂ is distributed to each connected node of the layer L₁ based on the respective link weight between the nodes and such that the sum of the relevance assigned to nodes of the layer L₁ from a particular node of the layer L₂ equals the relevance of the particular node of the layer L₂. For a particular node of the layer L₁, the relevance from different nodes of the layer L₂ are summed to form the relevance value of the particular node of the layer L₁. For example, the relevance (based on the predicted value of the first feature O₁) associated with node 1 is equal to the sum of the relevance allocated from node 5 based on the link weight w₁₅, the relevance allocated from node 6 based on the link weight w₁₆, and the relevance allocated from node 7 based on the link weight w₁₇. In the example illustrated in FIG. 3, the relevance (based on the predicted value of the first feature O₁) associated with node 1 is the feature relevance value FR′₁. Likewise, the relevance (based on the predicted value of the first feature O₁) associated with node 2 is equal to the sum of the relevance allocated from node 5 based on the link weight w₂₅, the relevance allocated from node 6 based on the link weight w₂₆, and the relevance allocated from node 7 based on the link weight w₂₇ and is the feature relevance value FR′₂. The feature relevance values FR′₃ and FR′₄ are determined in a similar manner.

When calculating the second set of feature relevance values 334 associated with the predicted value of the second feature O₂, similar operations to those described above are used to apportion relevance based on the predicted value of the second feature O₂ to each node that is connected (directly or via one or more other nodes) to node 9 of the output layer L₃. For example, the predicted value of the second feature O₂ is apportioned as relevance to each connected node of the layer L₂ based on the respective link weights between each node of the layer L₂ and node 9, and the relevance (based on the predicted value of the second feature O₂) associated with each node of the layer L₁ is equal to a sum of the relevance received (based on respective link weights) from each connected node of the layer L₂.

In the example illustrated in FIG. 3, the feature relevance aggregator 340 is configured to aggregate the first set of feature relevance values 324 and the second set of feature relevance values 334, feature-by-feature to generate a set 344 of aggregate feature relevance values. The set 344 of aggregate feature relevance values includes one aggregate feature relevance value for each feature of the input data 124. For example, aggregate feature relevance value AFR₁ is based on aggregation of feature relevance value FR′₁ and feature relevance value FR″₁, aggregate feature relevance value AFR₂ is based on aggregation of feature relevance value FR′₂ and feature relevance value FR″₂, aggregate feature relevance value AFR₃ is based on aggregation of feature relevance value FR′₃ and feature relevance value FR″₃, and aggregate feature relevance value AFR₄ is based on aggregation of feature relevance value FR′₄ and feature relevance value FR″₄. In a particular aspect, the set 344 of aggregate feature relevance value output by the feature relevance aggregator 340 is used as or corresponds to the feature relevance data 204 of FIGS. 2A or 2B.

In a particular implementation, the feature relevance aggregator 340 determines the aggregate feature relevance value for a particular feature by summing the feature relevance values for that feature. For example, the aggregate feature relevance value AFR₁ for the feature F₁ may be equal to a sum of the feature relevance value FR′₁ and feature relevance value FR″₁.

In some implementations, the feature relevance aggregator 340 determines the aggregate feature relevance value for a particular feature using a weighted sum of the feature relevance values for that feature. For example, AFR₁ can correspond to a weighted sum of the feature relevance value FR′₁ and feature relevance value FR″₁. where a first weight applied to the feature relevance value FR′₁ is based on a residual for O₁ and a second weight applied to the feature relevance value FR″₁ is based on a residual for O₂.

In some implementations, the predicted values of the features O₁ and O₂ can be negative. In such implementations, the feature relevance values determined by the layer-wise relevance propagation calculator 320 can be negative. In some such implementations, the feature relevance aggregator 340 determines the aggregate feature relevance value for a particular feature based on a sum (or weighted sum) of absolute values of the feature relevance values for that feature. For example, the aggregate feature relevance value AFR₁ may be equal to a sum (or a weighted sum) of the absolute value of the feature relevance value FR′₁ and the absolute value of the feature relevance value FR″₁.

In other implementations in which the feature relevance values determined by the layer-wise relevance propagation calculator 320 can be negative, negative feature relevance values may be treated differently than positive feature relevance values. To illustrate, the feature relevance aggregator 340 may determine the aggregate feature relevance value for a particular feature based on a sum (or weighted sum) of positive values of the feature relevance values for that feature, ignoring negative values of the feature relevance values for that feature. As another illustrative example, the feature relevance aggregator 340 may determine the aggregate feature relevance value for a particular feature based on a sum (or weighted sum) of negative values of the feature relevance values for that feature, ignoring positive values of the feature relevance values for that feature. As yet another illustrative example, the feature relevance aggregator 340 may determine the aggregate feature relevance value for a particular feature based on a weighted sum of negative values and positive values of the feature relevance values, where different weights are applied to the negative and positive values.

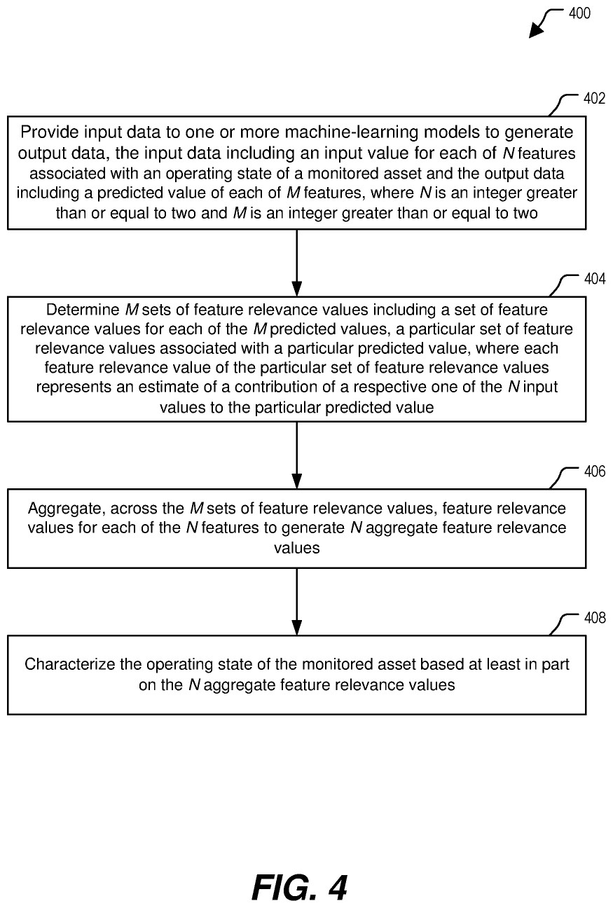

FIG. 4 is a flowchart representing a method that may be initiated, performed, or controlled by the system 100 of FIG. 1 or a portion there of, according to a particular implementation. For example, one or more operations described with reference to FIG. 4 may be performed by the monitoring system 120, such as by the processor(s) 104 executing the instructions 108.

The method 400 includes, at block 402, providing input data to one or more machine-learning models to generate output data. The input data includes an input value for each of N features associated with an operating state of a monitored asset, where N is an integer greater than or equal to two. The output data includes a predicted value of each of M features, where M is an integer greater than or equal to two. For example, the input data 124 may be provided as input to the behavior model 140 of any of FIGS. 1-3. In this example, the input data 124 includes values representing N features, and the behavior model 140 generates output data indicating M predicted values.

The method 400 includes, at block 404, determining M sets of feature relevance values including a set of feature relevance values for each of the M predicted values. A particular set of feature relevance values is associated with a particular predicted value, and each feature relevance value of the particular set of feature relevance values represents an estimate of a contribution of a respective one of the N input values to the particular predicted value. For example, the feature relevance calculator 142 of any of FIGS. 1-3 may receive as input the M predicted values generated by the behavior model 140 and generate as output M sets of N feature relevance values. To illustrate, in FIG. 3, the behavior model 140 receives N features as input and generates M predicted values (O₁ and O₂) where N is equal to 4 and M is equal to 2. In this illustrative example, the layer-wise relevance propagation calculator 320 receives as input the M predicted values and generates M sets of N feature relevance values (e.g., FR′₁-FR′₄ plus FR″₁-FR″₄).

The method 400 includes, at block 406, aggregating, across the M sets of feature relevance values, feature relevance values for each of the N features to generate N aggregate feature relevance values. For example, the feature relevance aggregator 340 of FIG. 3 aggregates feature relevance values to generate the aggregate feature relevance values AFR₁-AFR₄.

The method 400 includes, at block 408, characterizing the operating state of the monitored asset based at least in part on the N aggregate feature relevance values. For example, the operating state model 144 of any of FIGS. 1. 2A, or 2B generates the state data 128 characterizing the operating state of the monitored asset(s) 190.

In a particular aspect, characterization of an operating state of one or more monitored assets based on feature relevance data in accordance with the method 400 of FIG. 4 may provide additional insights into the operating state that would not be apparent from using the predicted values alone to characterize the operating state. For example, the feature relevance data may be used to provide earlier detection or prediction of abnormal operating states than use of the predicted values alone. As another example, the feature relevance data may be used to detect operating states that would not be readily detected using the predicted values alone. To illustrate, an unusually high contribution of a feature towards a predicted value can be an early indication of an anomalous operating state even though the predicted value has not yet exceeded a threshold. As a result, a monitoring system using the feature relevance data may be more reliable and/or may provide earlier detection of particular operating states than a monitoring system that uses only predicted values from a behavior model for operating state characterization.

FIG. 5 illustrates an example of a computer system 500 corresponding to one or more of the systems of FIGS. 1-3 according to particular implementations. For example, the computer system 500 is configured to initiate, perform, or control one or more of the operations described with reference to FIGS. 1-4. The computer system 500 can be implemented as or incorporated into one or more of various other devices, such as a personal computer (PC), a tablet PC, a server computer, a personal digital assistant (PDA), a laptop computer, a desktop computer, a communications device, a wireless telephone, or any other machine capable of executing a set of instructions (sequential or otherwise) that specify actions to be taken by that machine. Further, while a single computer system 500 is illustrated, the term “system” includes any collection of systems or sub-systems that individually or jointly execute a set, or multiple sets, of instructions to perform one or more computer functions.

While FIG. 5 illustrates one example of the computer system 500, other computer systems or computing architectures and configurations may be used for carrying out the automated model generation or asset monitoring operations disclosed herein. The computer system 500 includes the processor(s) 104. Each processor of the processor(s) 104 can include a single processing core or multiple processing cores that operate sequentially, in parallel, or sequentially at times and in parallel at other times. Each processor of the processor(s) 104 includes circuitry defining a plurality of logic circuits 502, working memory 504 (e.g., registers and cache memory), communication circuits, etc., which together enable the processor(s) 104 to control the operations performed by the computer system 500 and enable the processor(s) 104 to generate a useful result based on analysis of particular data and execution of specific instructions.

The processor(s) 104 are configured to interact with other components or subsystems of the computer system 500 via a bus 560. The bus 560 is illustrative of any interconnection scheme serving to link the subsystems of the computer system 500, external subsystems or devices, or any combination thereof. The bus 560 includes a plurality of conductors to facilitate communication of electrical and/or electromagnetic signals between the components or subsystems of the computer system 500. Additionally, the bus 560 includes one or more bus controllers or other circuits (e.g., transmitters and receivers) that manage signaling via the plurality of conductors and that cause signals sent via the plurality of conductors to conform to particular communication protocols.

The computer system 500 also includes one or more memory devices 106. The memory device(s) 106 include any suitable computer-readable storage device depending on, for example, whether data access needs to be bi-directional or unidirectional, speed of data access required, memory capacity required, other factors related to data access, or any combination thereof. Generally, the memory device(s) 106 includes some combinations of volatile memory devices and non-volatile memory devices, though in some implementations, only one or the other may be present. Examples of volatile memory devices and circuits include registers, caches, latches, many types of random-access memory (RAM), such as dynamic random-access memory (DRAM), etc. Examples of non-volatile memory devices and circuits include hard disks, optical disks, flash memory, and certain type of RAM, such as resistive random-access memory (ReRAM). Other examples of both volatile and non-volatile memory devices can be used as well, or in the alternative, so long as such memory devices store information in a physical, tangible medium. Thus, the memory device(s) 106 include circuits and structures and are not merely signals or other transitory phenomena (i.e., are non-transitory media).

In the example illustrated in FIG. 5, the memory device(s) 106 store the instructions 108 that are executable by the processor(s) 104 to perform various operations and functions. The instructions 108 include instructions to enable the various components and subsystems of the computer system 500 to operate, interact with one another, and interact with a user, such as a basic input/output system (BIOS) 552 and an operating system (OS) 554. Additionally, the instructions 108 include one or more applications 556, scripts, or other program code to enable the processor(s) 104 to perform the operations described herein. For example, in FIG. 5, the instructions 108 include instructions corresponding to the monitoring system 120 of FIG. 1. In the particular implementation illustrated in FIG. 5, the monitoring system 120 is executable by the processor(s) 104 to detect an operating state of the monitored asset(s) 190 of FIG. 1. As one example, the instructions 108 may include instructions that, when executed, cause the processor(s) 104 to provide input data to one or more behavior model(s) 140 to generate output data. The input data includes an input value for each of N features associated with an operating state of a monitored asset, where N is an integer greater than or equal to two. The output data includes a predicted value of each of M features, where M is an integer greater than or equal to two. The instructions 108, when executed, further cause the processor(s) 104 to determine M sets of feature relevance values including a set of feature relevance values for each of the M predicted values. A particular set of feature relevance values is associated with a particular predicted value, and each feature relevance value of the particular set of feature relevance values represents an estimate of a contribution of a respective one of the N input values to the particular predicted value. The instructions 108, when executed, also cause the processor(s) 104 to aggregate, across the M sets of feature relevance values, feature relevance values for each of the N features to generate N aggregate feature relevance values. The instructions 108, when executed, further cause the processor(s) 104 to characterize the operating state of the monitored asset based at least in part on the N aggregate feature relevance values.

In FIG. 5, the computer system 500 also includes one or more output devices 530, one or more input devices 520, and one or more interface devices 118. Each of the output device(s) 530, the input device(s) 520, and the interface device(s) 118 can be coupled to the bus 560 via a port or connector, such as a Universal Serial Bus port, a digital visual interface (DVI) port, a serial ATA (SATA) port, a small computer system interface (SCSI) port, a high-definition media interface (HDMI) port, or another serial or parallel port. In some implementations, one or more of the output device(s) 530, the input device(s) 520, the interface device(s) 118 is coupled to or integrated within a housing with the processor(s) 104 and the memory device(s) 106, in which case the connections to the bus 560 can be internal, such as via an expansion slot or other card-to-card connector. In other implementations, the processor(s) 104 and the memory device(s) 106 are integrated within a housing that includes one or more external ports, and one or more of the output device(s) 530, the input device(s) 520, the interface device(s) 118 is coupled to the bus 560 via the external port(s).

Examples of the output device(s) 530 include the display device(s) 150, speakers, printers, televisions, projectors, or other devices to provide output of data in a manner that is perceptible by a user. Examples of the input device(s) 520 include buttons, switches, knobs, a keyboard 522, a pointing device 524, a biometric device, a microphone, a motion sensor, or another device to detect user input actions. The pointing device 524 includes, for example, one or more of a mouse, a stylus, a track ball, a pen, a touch pad, a touch screen, a tablet, another device that is useful for interacting with a graphical user interface, or any combination thereof. A particular device may be an input device 520 and an output device 530. For example, the particular device may be a touch screen.

The interface device(s) 118 are configured to enable the computer system 500 to communicate with one or more other devices 544 directly or via one or more networks 540. For example, the interface device(s) 118 may encode data in electrical and/or electromagnetic signals that are transmitted to the other device(s) 544 as control signals or packet-based communication using pre-defined communication protocols. As another example, the interface device(s) 118 may receive and decode electrical and/or electromagnetic signals that are transmitted by the other device(s) 544. To illustrate, the other device(s) 544 may include the sensor(s) 192 of FIG. 1. The electrical and/or electromagnetic signals can be transmitted wirelessly (e.g., via propagation through free space), via one or more wires, cables, optical fibers, or via a combination of wired and wireless transmission.

In an alternative embodiment, dedicated hardware implementations, such as application specific integrated circuits, programmable logic arrays and other hardware devices, can be constructed to implement one or more of the operations described herein. Accordingly, the present disclosure encompasses software, firmware, and hardware implementations.

The systems and methods illustrated herein may be described in terms of functional block components, screen shots, optional selections, and various processing steps. It should be appreciated that such functional blocks may be realized by any number of hardware and/or software components configured to perform the specified functions. For example, the system may employ various integrated circuit components, e.g., memory elements, processing elements, logic elements, look-up tables, and the like, which may carry out a variety of functions under the control of one or more microprocessors or other control devices. Similarly, the software elements of the system may be implemented with any programming or scripting language such as C. C++, C#, Java, JavaScript, VBScript, Macromedia Cold Fusion, COBOL, Microsoft Active Server Pages, assembly, PERL, PHP, AWK, Python, Visual Basic, SQL Stored Procedures, PL/SQL, any UNIX shell script, and extensible markup language (XML) with the various algorithms being implemented with any combination of data structures, objects, processes, routines, or other programming elements. Further, it should be noted that the system may employ any number of techniques for data transmission, signaling, data processing, network control, and the like.

The systems and methods of the present disclosure may be embodied as a customization of an existing system, an add-on product, a processing apparatus executing upgraded software, a standalone system, a distributed system, a method, a data processing system, a device for data processing, and/or a computer program product. Accordingly, any portion of the system or a module or a decision model may take the form of a processing apparatus executing code, an internet based (e.g., cloud computing) embodiment, an entirely hardware embodiment, or an embodiment combining aspects of the internet, software, and hardware. Furthermore, the system may take the form of a computer program product on a computer-readable storage medium or device having computer-readable program code (e.g., instructions) embodied or stored in the storage medium or device. Any suitable computer-readable storage medium or device may be utilized, including hard disks, CD-ROM, optical storage devices, magnetic storage devices, and/or other storage media. As used herein, a “computer-readable storage medium” or “computer-readable storage device” is not a signal.

Systems and methods may be described herein with reference to screen shots, block diagrams, and flowchart illustrations of methods, apparatuses (e.g., systems), and computer media according to various aspects. It will be understood that each functional block of a block diagram and flowchart illustration, and combinations of functional blocks in block diagrams and flowchart illustrations, respectively, can be implemented by computer program instructions.

Computer program instructions may be loaded onto a computer or other programmable data processing apparatus to produce a machine, such that the instructions that execute on the computer or other programmable data processing apparatus create means for implementing the functions specified in the flowchart block or blocks. These computer program instructions may also be stored in a computer-readable memory or device that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions.

Particular aspects of the disclosure are described below in the following Examples:
According to Example 1, a method includes: providing input data to one or more machine-learning models to generate output data, the input data including an input value for each of N features associated with an operating state of a monitored asset and the output data including a predicted value of each of M features, wherein N is an integer greater than or equal to two and M is an integer greater than or equal to two; determining M sets of feature relevance values including a set of feature relevance values for each of the M predicted values, a particular set of feature relevance values associated with a particular predicted value, wherein each feature relevance value of the particular set of feature relevance values represents an estimate of a contribution of a respective one of the N input values to the particular predicted value; aggregating, across the M sets of feature relevance values, feature relevance values for each of the N features to generate N aggregate feature relevance values; and characterizing the operating state of the monitored asset based at least in part on the N aggregate feature relevance values.
Example 2 includes the method of Example 1, wherein the characterizing the operating state of the monitored asset is further based at least in part on the output data.
Example 3 includes the method of Example 1 or Example 2, wherein the characterizing the operating state of the monitored asset includes providing input based at least in part on the N aggregate feature relevance values to an operating state model to generate an operating state output.
Example 4 includes the method of Example 3, wherein the operating state output indicates whether the operating state of the monitored asset is an anomalous operating state.
Example 5 includes the method of Example 3 or Example 4, further including determining one or more residual data values based on comparison of each of the M predicted values to an actual value of a corresponding feature of the M features, wherein the input to the operating state model is further based on the one or more residual data values.
Example 6 includes the method of Example 5, wherein the one or more residual data values include M residual data values.
Example 7 includes the method of any of Examples 1 to 6, wherein the one or more machine-learning models include one or more autoencoders.
Example 8 includes the method of any of Examples 1 to 7, wherein N is equal to M.
Example 9 includes the method of any of Examples 1 to 7, wherein N is less than M.
Example 10 includes the method of any of Examples 1 to 7, wherein N is greater than M.
Example 11 includes the method of any of Examples 1 to 10, wherein one or more of the N features represents sensor data values from one or more sensors associated with the monitored asset.
Example 12 includes the method of any of Examples 1 to 11, wherein the determining the M sets of feature relevance values includes performing layer-wise relevance propagation for each of the M predicted values.
Example 13 includes the method of any of Examples 1 to 12, further including generating one or more control signals based on characterization of the operating state of the monitored asset.
According to Example 14, a system includes: one or more memory devices storing processor-executable instructions and one or more processors configured to execute the instructions to: provide input data to one or more machine-learning models to generate output data, the input data including an input value for each of N features associated with an operating state of a monitored asset and the output data including a predicted value of each of M features, wherein N is an integer greater than or equal to two and M is an integer greater than or equal to two; determine M sets of feature relevance values including a set of feature relevance values for each of the M predicted values, a particular set of feature relevance values associated with a particular predicted value, wherein each feature relevance value of the particular set of feature relevance values represents an estimate of a contribution of a respective one of the N input values to the particular predicted value; aggregate, across the M sets of feature relevance values, feature relevance values for each of the N features to generate N aggregate feature relevance values; and characterize the operating state of the monitored asset based at least in part on the N aggregate feature relevance values.
Example 15 includes the system of Example 14, wherein characterizing the operating state of the monitored asset is further based at least in part on the output data.
Example 16 includes the system of Example 14 or Example 15, wherein characterizing the operating state of the monitored asset includes providing input based at least in part on the N aggregate feature relevance values to an operating state model to generate an operating state output.
Example 17 includes the system of Example 16, wherein the operating state output indicates whether the operating state of the monitored asset is an anomalous operating state.
Example 18 includes the system of Example 16 or Example 17, wherein execution of the instructions further causes the one or more processors to determine one or more residual data values based on comparison of each of the M predicted values to an actual value of a corresponding feature of the M features, wherein the input to the operating state model is further based on the one or more residual data values.
Example 19 includes the system of Example 18, wherein the one or more residual data values include M residual data values.
Example 20 includes the system of any of Examples 14 to 19, wherein the one or more machine-learning models include one or more autoencoders.
Example 21 includes the system of any of Examples 14 to 20, wherein N is equal to M.
Example 22 includes the system of any of Examples 14 to 20, wherein N is less than M.
Example 23 includes the system of any of Examples 14 to 20, wherein N is greater than M.
Example 24 includes the system of any of Examples 14 to 23, wherein one or more of the N features represents sensor data values from one or more sensors associated with the monitored asset.
Example 25 includes the system of any of Examples 14 to 24, wherein determining the M sets of feature relevance values includes performing layer-wise relevance propagation for each of the M predicted values.
Example 26 includes the system of any of Examples 14 to 25, further including one or more interface devices coupled to the one or more processors, wherein execution of the instructions further causes the one or more processors to send one or more control signals, via the one or more interface devices, based on characterization of the operating state of the monitored asset.
According to Example 27, a non-transitory processor-readable storage device stores processor-executable instructions that are executable by one or more processors to perform operations including: providing input data to one or more machine-learning models to generate output data, the input data including an input value for each of N features associated with an operating state of a monitored asset and the output data including a predicted value of each of M features, wherein N is an integer greater than or equal to two and M is an integer greater than or equal to two; determining M sets of feature relevance values including a set of feature relevance values for each of the M predicted values, a particular set of feature relevance values associated with a particular predicted value, wherein each feature relevance value of the particular set of feature relevance values represents an estimate of a contribution of a respective one of the N input values to the particular predicted value; aggregating, across the M sets of feature relevance values, feature relevance values for each of the N features to generate N aggregate feature relevance values; and characterizing the operating state of the monitored asset based at least in part on the N aggregate feature relevance values.
Example 28 includes the non-transitory processor-readable storage device of Example 27, wherein characterizing the operating state of the monitored asset is further based at least in part on the output data.
Example 29 includes the non-transitory processor-readable storage device of Example 27 or Example 28, wherein characterizing the operating state of the monitored asset includes providing input based at least in part on the N aggregate feature relevance values to an operating state model to generate an operating state output.
Example 30 includes the non-transitory processor-readable storage device of Example 29, wherein the operating state output indicates whether the operating state of the monitored asset is an anomalous operating state.
Example 31 includes the non-transitory processor-readable storage device of Example 29 or Example 30, wherein the operations further include determining one or more residual data values based on comparison of each of the M predicted values to an actual value of a corresponding feature of the M features, wherein the input to the operating state model is further based on the one or more residual data values.
Example 32 includes the non-transitory processor-readable storage device of Example 31, wherein the one or more residual data values include M residual data values.
Example 33 includes the non-transitory processor-readable storage device of any of Examples 27 to 32, wherein the one or more machine-learning models include one or more autoencoders.
Example 34 includes the non-transitory processor-readable storage device of any of Examples 27 to 33, wherein N is equal to M.
Example 35 includes the non-transitory processor-readable storage device of any of Examples 27 to 33, wherein N is less than M.
Example 36 includes the non-transitory processor-readable storage device of any of Examples 27 to 33, wherein N is greater than M.
Example 37 includes the non-transitory processor-readable storage device of any of Examples 27 to 36, wherein one or more of the N features represents sensor data values from one or more sensors associated with the monitored asset.
Example 38 includes the non-transitory processor-readable storage device of any of Examples 27 to 37, wherein determining the M sets of feature relevance values includes performing layer-wise relevance propagation for each of the M predicted values.
Example 39 includes the non-transitory processor-readable storage device of any of Examples 27 to 38, wherein the operations further include generating one or more control signals based on characterization of the operating state of the monitored asset.

Although the disclosure may include one or more methods, it is contemplated that it may be embodied as computer program instructions on a tangible computer-readable medium, such as a magnetic or optical memory or a magnetic or optical disk/disc. All structural, chemical, and functional equivalents to the elements of the above-described exemplary embodiments that are known to those of ordinary skill in the art are expressly incorporated herein by reference and are intended to be encompassed by the present claims. Moreover, it is not necessary for a device or method to address each and every problem sought to be solved by the present disclosure, for it to be encompassed by the present claims. Furthermore, no element, component, or method step in the present disclosure is intended to be dedicated to the public regardless of whether the element, component, or method step is explicitly recited in the claims. As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

Changes and modifications may be made to the disclosed embodiments without departing from the scope of the present disclosure. These and other changes or modifications are intended to be included within the scope of the present disclosure, as expressed in the following claims.

What is claimed is:

1. A method comprising:
providing input data to one or more machine-learning models to generate output data, the input data including an input value for each of N features associated with an operating state of a monitored asset and the output data including a predicted value of each of M features, wherein N is an integer greater than or equal to two and M is an integer greater than or equal to two;
determining M sets of feature relevance values including a set of feature relevance values for each of the M predicted values, a particular set of feature relevance values associated with a particular predicted value, wherein each feature relevance value of the particular set of feature relevance values represents an estimate of a contribution of a respective one of the N input values to the particular predicted value;
aggregating, across the M sets of feature relevance values, feature relevance values for each of the N features to generate N aggregate feature relevance values; and
characterizing the operating state of the monitored asset based at least in part on the N aggregate feature relevance values.

2. The method of claim 1, wherein the characterizing the operating state of the monitored asset is further based at least in part on the output data.

3. The method of claim 1, wherein the characterizing the operating state of the monitored asset comprises providing input based at least in part on the N aggregate feature relevance values to an operating state model to generate an operating state output.

4. The method of claim 3, wherein the operating state output indicates whether the operating state of the monitored asset is an anomalous operating state.

5. The method of claim 3, further comprising determining one or more residual data values based on comparison of each of the M predicted values to an actual value of a corresponding feature of the M features, wherein the input to the operating state model is further based on the one or more residual data values.

6. The method of claim 5, wherein the one or more residual data values include M residual data values.

7. The method of claim 1, wherein the one or more machine-learning models include one or more autoencoders.

8. The method of claim 1, wherein N is equal to M.

9. The method of claim 1, wherein N is less than M.

10. The method of claim 1, wherein N is greater than M.

11. The method of claim 1, wherein one or more of the N features represents sensor data values from one or more sensors associated with the monitored asset.

12. The method of claim 1, wherein the determining the M sets of feature relevance values comprises performing layer-wise relevance propagation for each of the M predicted values.

13. The method of claim 1, further comprising generating one or more control signals based on characterization of the operating state of the monitored asset.

14. A system comprising:
one or more memory devices storing processor-executable instructions; and
one or more processors configured to execute the instructions to:
provide input data to one or more machine-learning models to generate output data, the input data including an input value for each of N features associated with an operating state of a monitored asset and the output data including a predicted value of each of M features, wherein N is an integer greater than or equal to two and M is an integer greater than or equal to two;
determine M sets of feature relevance values including a set of feature relevance values for each of the M predicted values, a particular set of feature relevance values associated with a particular predicted value, wherein each feature relevance value of the particular set of feature relevance values represents an estimate of a contribution of a respective one of the N input values to the particular predicted value;
aggregate, across the M sets of feature relevance values, feature relevance values for each of the N features to generate N aggregate feature relevance values; and
characterize the operating state of the monitored asset based at least in part on the N aggregate feature relevance values.

15. The system of claim 14, wherein characterizing the operating state of the monitored asset is further based at least in part on the output data.

16. The system of claim 14, wherein characterizing the operating state of the monitored asset comprises providing input based at least in part on the N aggregate feature relevance values to an operating state model to generate an operating state output.

17. The system of claim 16, wherein the operating state output indicates whether the operating state of the monitored asset is an anomalous operating state.

18. The system of claim 16, wherein execution of the instructions further causes the one or more processors to determine one or more residual data values based on comparison of each of the M predicted values to an actual value of a corresponding feature of the M features, wherein the input to the operating state model is further based on the one or more residual data values.

19. The system of claim 18, wherein the one or more residual data values include M residual data values.

20. The system of claim 14, wherein the one or more machine-learning models include one or more autoencoders.

21. The system of claim 14, wherein N is equal to M.

22. The system of claim 14, wherein N is less than M.

23. The system of claim 14, wherein N is greater than M.

24. The system of claim 14, wherein one or more of the N features represents sensor data values from one or more sensors associated with the monitored asset.

25. The system of claim 14, wherein determining the M sets of feature relevance values comprises performing layer-wise relevance propagation for each of the M predicted values.

26. The system of claim 14, further comprising one or more interface devices coupled to the one or more processors, wherein execution of the instructions further causes the one or more processors to send one or more control signals, via the one or more interface devices, based on characterization of the operating state of the monitored asset.

27. A non-transitory processor-readable storage device storing processor-executable instructions that are executable by one or more processors to perform operations including:
providing input data to one or more machine-learning models to generate output data, the input data including an input value for each of N features associated with an operating state of a monitored asset and the output data including a predicted value of each of M features, wherein N is an integer greater than or equal to two and M is an integer greater than or equal to two;
determining M sets of feature relevance values including a set of feature relevance values for each of the M predicted values, a particular set of feature relevance values associated with a particular predicted value, wherein each feature relevance value of the particular set of feature relevance values represents an estimate of a contribution of a respective one of the N input values to the particular predicted value;
aggregating, across the M sets of feature relevance values, feature relevance values for each of the N features to generate N aggregate feature relevance values; and
characterizing the operating state of the monitored asset based at least in part on the N aggregate feature relevance values.

28. The non-transitory processor-readable storage device of claim 27, wherein characterizing the operating state of the monitored asset is further based at least in part on the output data.

29. The non-transitory processor-readable storage device of claim 27, wherein characterizing the operating state of the monitored asset comprises providing input based at least in part on the N aggregate feature relevance values to an operating state model to generate an operating state output.

30. The non-transitory processor-readable storage device of claim 29, wherein the operating state output indicates whether the operating state of the monitored asset is an anomalous operating state.

31. The non-transitory processor-readable storage device of claim 29, wherein the operations further comprise determining one or more residual data values based on comparison of each of the M predicted values to an actual value of a corresponding feature of the M features, wherein the input to the operating state model is further based on the one or more residual data values.

32. The non-transitory processor-readable storage device of claim 31, wherein the one or more residual data values include M residual data values.

33. The non-transitory processor-readable storage device of claim 27, wherein the one or more machine-learning models include one or more autoencoders.

34. The non-transitory processor-readable storage device of claim 27, wherein N is equal to M.

35. The non-transitory processor-readable storage device of claim 27, wherein N is less than M.

36. The non-transitory processor-readable storage device of claim 27, wherein N is greater than M.

37. The non-transitory processor-readable storage device of claim 27, wherein one or more of the N features represents sensor data values from one or more sensors associated with the monitored asset.

38. The non-transitory processor-readable storage device of claim 27, wherein determining the M sets of feature relevance values comprises performing layer-wise relevance propagation for each of the M predicted values.

39. The non-transitory processor-readable storage device of claim 27, wherein the operations further comprise generating one or more control signals based on characterization of the operating state of the monitored asset.
